(19) United States
(12) Patent Application Publication
(10) Pub. No.: US 2026/0138238 A1
(43) Pub. Date: May 21, 2026

(54) FLIPPABLE RAIL CLAMP

(71) Applicant: SNR Solar LLC, San Luis Obispo, CA (US)

(72) Inventor: Martin John Affentranger, Jr., Paso Robles, CA (US)

(21) Appl. No.: 18/952,470

(22) Filed: Nov. 19, 2024

(51) Int. Cl. B25B 5/14; F16M 13/02

(52) U.S. Cl. CPC B25B 5/14; F16M 13/022

(57) ABSTRACT

A flippable rail clamp is described herein. The flippable rail clamp, when rotated 90 degrees, allows unobstructed driver access to a fastener located directly beneath the rail. The rotation of the clamp centers the load of the rail directly over the fastener to improve loading dynamics of the system. In an example embodiment, the flippable rail clamp includes a hinge point wherein the flippable rail clamp attaches to a mount and a first flange and a second flange for connecting a rail. The flippable rail clamp rotates about the hinge point 90° to allow a driver unobstructed access to a hole located below the flippable rail clamp.

### FIELD OF INVENTION

This application is in the field of solar panel clamps.

### BACKGROUND

Building-mounted structures are typically secured to a building surface with one or more mounting assemblies. Such assemblies may include multiple components which coupled together to facilitate, for example, the ability to raise and lower track assemblies above an installation surface to which solar panel modules may be mounted during the installation of systems designed to generate solar power. One of these components could be a clamp which couples together two members of the mounting assembly in an arrangement desired for the installation. While clamps provide necessary functions to the installation process, each could be comprised of at least four separate components which an installer needs to handle simultaneously during the installation process: a threaded fastener, a nut, and two opposing members for providing a clamping force imparted by the tightening force applied to threaded fastener traversing through apertures of the opposing members to engage the nut with the proper amount of torque. During the installation of a solar power generation system, a significant delay can buildup due to the number of parts being fitted together.

### SUMMARY

A flippable rail clamp is described herein. The flippable rail clamp, when rotated 90 degrees, allows unobstructed driver access to a fastener located directly beneath the rail. The rotation of the clamp centers the load of the rail directly over the fastener to improve loading dynamics of the system.

In an example embodiment, the flippable rail clamp may include a hinge point wherein the flippable rail clamp attaches to a mount and a first flange and a second flange for connecting a rail. The flippable rail clamp rotates about the hinge point 90° to allow a driver unobstructed access to a hole located below the flippable rail clamp.

### BRIEF DESCRIPTION OF THE DRAWINGS

FIGS. 1A and 1B are examples of a flippable rail clamp;

FIG. 2 is an example of a flippable rail clamp rotated 90° to allow access to a fastener directly beneath the rail;

FIG. 3A-3C are an example of a flippable rail clamp as it rotates; and

FIG. 4A-4E are example embodiments of a flippable rail clamp;

### DETAILED DESCRIPTION OF THE DRAWINGS

In the following description, several specific details are presented to provide a thorough understanding of embodiments of the inventive concepts disclosed herein. One skilled in the relevant art will recognize, however, that the inventive concepts disclosed herein can be practiced without one or more of the specific details or in combination with other components. In other instances, well-known implementations or operations are not shown or described in detail to avoid obscuring aspects of various embodiments of the inventive concepts disclosed herein.

A flippable rail clamp is described herein. The flippable rail clamp, when rotated 90 degrees, allows driver access to a fastener located directly beneath the rail. The rotation of the clamp centers the load of the rail directly over the fastener to improve loading dynamics of the system.

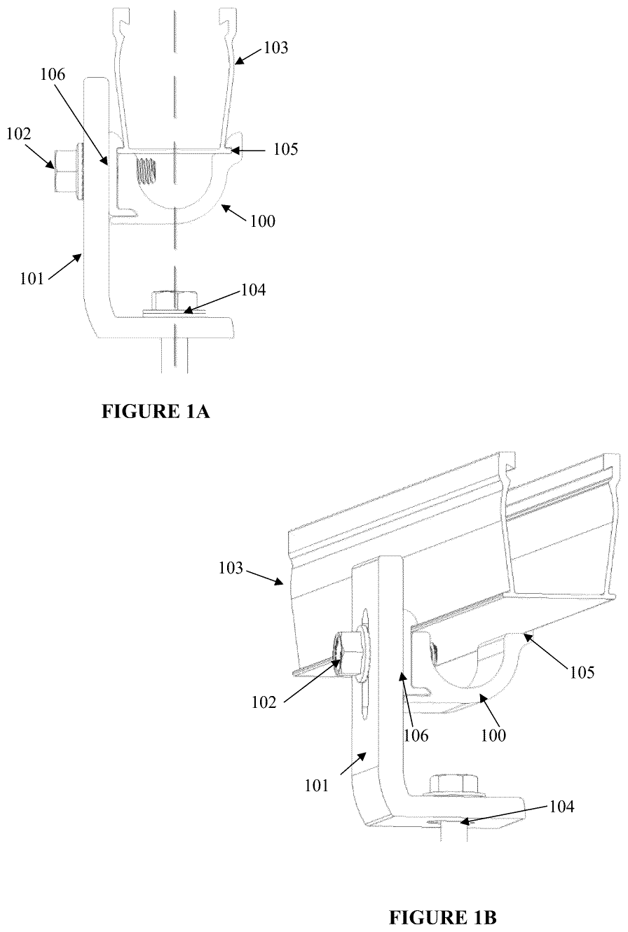

FIGS. 1A and 1B are examples of a flippable rail clamp. FIG. 1A shows a side view while FIG. 1B shows a perspective view of the flippable rail clamp. The flippable rail clamp 100 may be attached to a mount 101. The flippable rail clamp 100 may be attached to the mount 101 with a fastener 102 at a hinge point 106. For example, the fastener 102 may be a bolt or the like. The flippable rail clamp 100 may rotate about the hinge point 106 90° to allow a driver unobstructed access to a hole located below the flippable rail clamp 100. A rail 103 may be attached to the flippable rail clamp 100 by snapping into a flange 105. The mount 101 may have a hole 104 as a point of attachment to an insulation surface, for example a roof. Once the flippable rail clamp 100 is attached to the mount 101, the flippable rail clamp 100 can rotate 90° allowing a user unobstructed access to the hole 104 (or point of attachment) below the flippable rail clamp 100.

The center of the load of the rail 103 may be directly over the fastener 102 to improve loading dynamics of the system. Additionally, without this ease of unobstructed access, a user would have to first remove a rail clamp from the track, access the hole, and then reattach a rail clamp. Alternatively, the flippable rail clamp and the mount may be sold separately for assembly during installation.

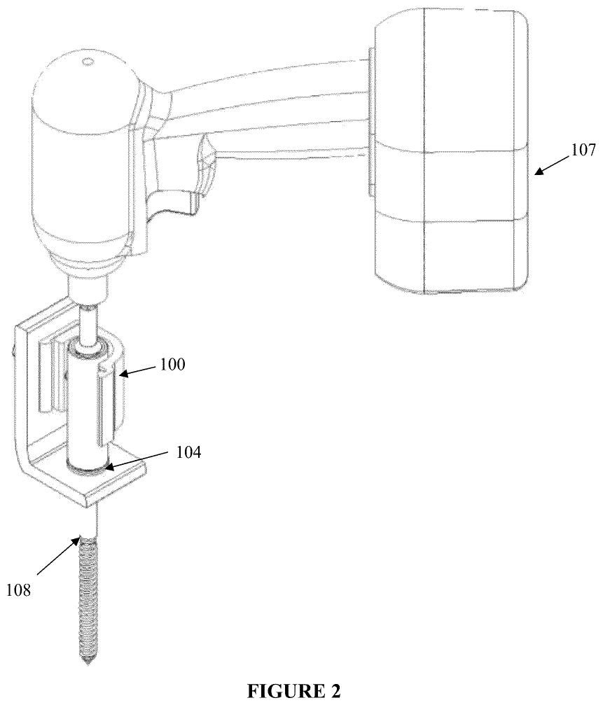

FIG. 2 is an example of a flippable rail clamp rotated 90° to allow unobstructed access to a fastener directly beneath the rail. When the flippable rail clamp 100 is rotated 90°, so that the flippable rail clamp 100 is on its side, it allows unobstructed driver access to a fastener 108 located directly beneath the flippable rail clamp 100. The rotation of the flippable rail clamp 100 allows a driver 107 easy unobstructed access to a point of attachment 104 to an insulation surface.

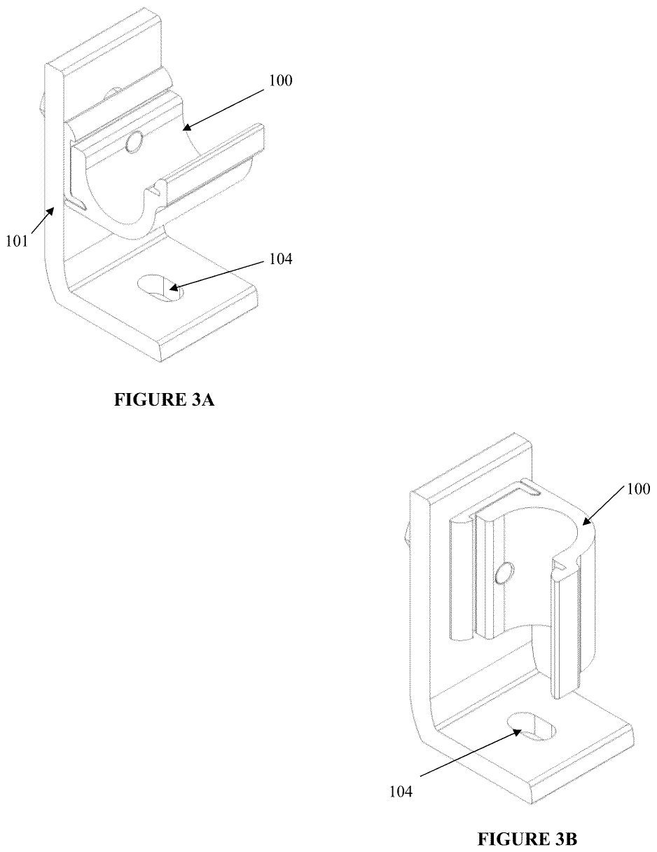

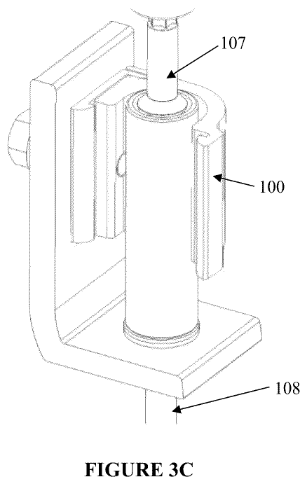

FIG. 3A-3C are an example of a flippable rail clamp as it rotates. In FIG. 3A, the flippable rail clamp 100 is positioned in a ready to receive position; meaning that the flippable rail clamp 101 is ready to receive a rail attachment. As illustrated in FIG. 3A, the flippable rail clamp 100 is unobstructed, meaning the fastener at the hinge point, is not protruding through the flippable rail clamp 100. Instead the fastener remains only through the mount 101 and through the clamp at the hinge point. Additionally, the hole 104 is shown to be directly below the flippable rail clamp 100.

In FIG. 3B, the flippable rail clamp 100 is rotated 90° to allow unobstructed driver access to a fastener (not shown) located below the flippable rail clamp. As illustrated in FIG. 3B, when flippable rail clamp 100 is rotated 90°, the user now has access to the hole 104 below.

In FIG. 3C, the flippable rail clamp 100 is still in the rotate position, but is shown with a driver 107. The driver 107 may easily fit within the curvature of the flippable rail clamp 100 and is able to easily access the fastener 108 below.

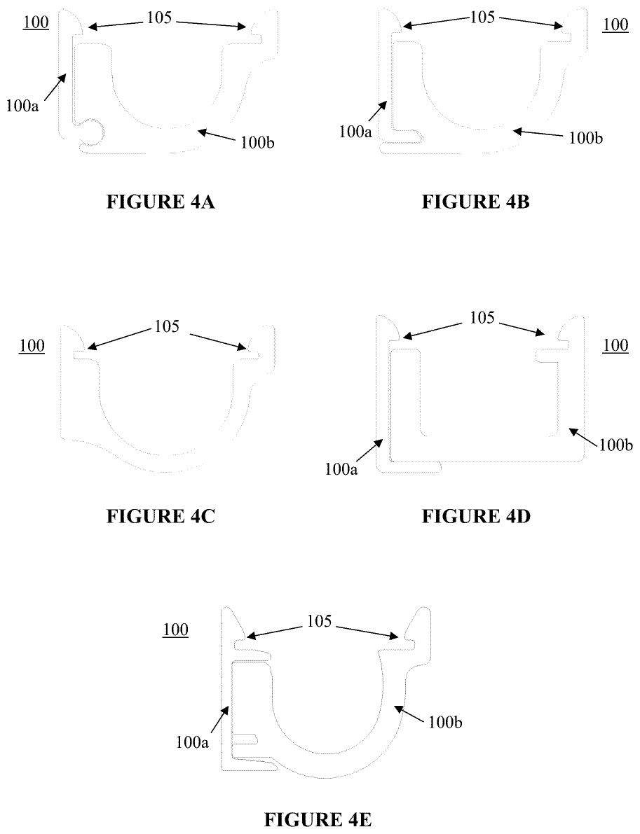

FIG. 4A-4E are example embodiments of a flippable rail clamp. FIG. 4A is a first example two-piece flippable rail clamp 100. A first piece 100a may have a convex male portion that fits into a concave female portion of a second piece 100b. Both the first piece 100a and the second piece 100b of the flippable rail clamp have flanges 105. As illustrated in FIG. 4A, the flippable rail clamp 100 is a semi-circular shape to receive a circular-shaped driver.

FIG. 4B is a second example of a two-piece flippable rail clamp 100. A first piece 100a may have a male L-joint that fits into a female L-joint of a second piece 100b. Both the first piece 100a and the second piece 100b of the flippable rail clamp 100 have flanges 105.

FIG. 4C is an example of single piece flippable rail 100. The flippable rail clamp 100 has flanges 105 on both the left and right side.

FIG. 4D is a third example of a two-piece flippable rail clamp 100. A second piece 100b fits nestled into a first piece 100a. Both the first piece 100a and the second piece 100b of the flippable rail clamp 100 have flanges 105. As illustrated in FIG. 4D, the flippable rail clamp 100 as a square shape for receiving a square-shaped driver.

FIG. 4E is a fourth example of a two-piece flippable rail clamp 100. A first piece 100a may have a double male joint that fits into and around a female joint of a second piece 100b. Both the first piece 100a and the second piece 100b of the flippable rail clamp 100 have flanges 105. As illustrated in FIG. 4E, the flippable rail clamp 100 as an oblong shape for receiving an oblong-shaped driver.

It should be understood that the aspects, features and advantages made apparent from the foregoing are efficiently attained and, since certain changes may be made in the disclosed inventive embodiments without departing from the spirit and scope of the invention, it is intended that all matter contained herein shall be interpreted as illustrative and not in a limiting sense.

What is claimed:

1. A flippable rail clamp comprising:
a flippable rail clamp;
a hinge point wherein the flippable rail clamp attaches to a mount; and
a first flange and a second flange for connecting a rail;
wherein the flippable rail clamp rotates about the hinge point 90° to allow a driver unobstructed access to a hole located below the flippable rail clamp.

2. The flippable rail clamp of claim 1, wherein the flippable rail clamp is two pieces.

3. The flippable rail clamp of claim 1, wherein the flippable rail clamp is a singular piece.

4. The flippable rail clamp of claim 1, wherein the flippable rail clamp is attached to the mount with a fastener.

5. The flippable rail clamp of claim 1, wherein the flippable rail clamp snaps on the rail at the first and second flanges.

6. The flippable rail clamp of claim 1, wherein the flippable rail clamp is a semi-circle shape.

7. The flippable rail clamp of claim 1, wherein the flippable rail clamp is a square shape.

8. The flippable rail clamp of claim 1, wherein the flippable rail clamp is an oblong shape.
